(19) United States
(12) Patent Application Publication
(10) Pub. No.: US 2025/0028953 A1
(43) Pub. Date: Jan. 23, 2025

(54) CLASSIFIER LEARNING SYSTEM AND CLASSIFIER GENERATION SYSTEM INCLUDING THE SAME

(71) Applicant: ELECTRONICS AND TELECOMMUNICATIONS RESEARCH INSTITUTE, Daejeon (KR)

(72) Inventors: JUNGHOON LEE, Daejeon (KR); Cheol Ho Kim, Daejeon (KR)

(21) Appl. No.: 18/604,157

(22) Filed: Mar. 13, 2024

(30) Foreign Application Priority Data
Jul. 19, 2023 (KR) 10-2023-0094077

(51) Int. Cl. G06N 3/08

(52) U.S. Cl. CPC G06N 3/08

(57) ABSTRACT

Disclosed is a classifier learning system, which includes a classifier that trains training data having a feature space including a plurality of features based on a classification algorithm, a feature weight generation module that generates a feature weight based on an artificial neural network and an amount of mutual information between the plurality of features of the training data, and a data sampling module that generates sampling data by performing a feature space restoration operation based on the training data and a previous feature space of previous data on which the training is completed in the classifier, and the classifier trains the sampling data, and the classifier includes a plurality of feature-specific classifiers to which the feature weights corresponding to each of the plurality of features are assigned.

### CROSS-REFERENCE TO RELATED APPLICATIONS

This application claims priority under 35 U.S.C. § 119 to Korean Patent Application No. 10-2023-0094077 filed on Jul. 19, 2023, in the Korean Intellectual Property Office, the disclosures of which are incorporated by reference herein in their entireties.

### BACKGROUND

Embodiments of the present disclosure described herein relate to a classifier learning system and a classifier generation system including the same, and more particularly, relate to a system that generates a classifier that operates even in environments where a feature space of training data is variable.

Classifiers are a representative supervised learning technology that is widely used in various fields such as a medical treatment, an IoT (Internet Of Things), and smart factories. Various classification algorithms are being researched and utilized, such as Naive Bayes that approximates joint probability distributions through probability distributions for each feature, trees and random forests that create complex decision boundaries by repeating simple classifications, support vector machines (SVM) that find a hyperplane, which may classify given data with the largest margin, and artificial neural networks that approximate complex nonlinear functions by stacking multiple layers.

In particular, research on progressive learning is being actively conducted recently to efficiently train and utilize data continuously generated in various environments. When training data that is already collected, it is relatively easy to train a single classifier capable of accessing all data. However, when data is continuously added over time, the classifier should be newly trained each time data is added, which is very inefficient. In addition, since it is not realistically easy the act of collecting personal information-related data in one place for learning in the first place, an algorithm is needed that may achieve an effect equivalent to learning the entire data at once while learning individual data separately. Accordingly, progressive learning basically aims to obtain performance equivalent to learning the entire data by individually learning multiple data sets that are separated in time and space.

The progressive learning is called by slightly different names depending on the specific problem situation and purpose. For example, there are continual learning, in which objects to be classified are continuously added, online learning, where cumulative accuracy on streaming data is important, domain adaptation to adapt to changing domains, and federated learning that creates a single model through multiple spatially separated data sets.

However, since most of the above-described methodologies are designed assuming a fixed feature space, it is difficult to use them to use in an environment where the feature space itself is variable. In fact, structured data frequently used in environments such as a medical treatment, an IoT, and smart factories often changes the feature space. Sensors for data collection may be added or reduced, the data collection environment may change, and the items tested may vary from hospital to hospital. In this case, to combine data sets consisting of different features, an expert should select features or fill in missing values using an algorithm, but this methods are unsuitable for processing large amounts of missing values that continuously come in.

In addition, unlike the continual learning and online learning, the collection of knowledge is important in progressive learning with respect to a variable feature space. For example, in the continual learning, a model that trained on dogs and cats only needs to be able to recognize dogs or cats. However, a model that trained on a feature space A={F1, F2, and F3} and a feature space B={F4, F5, and F6} in the variable feature space is intended to operate not only on the feature spaces A and B but also on new spaces composed of the combination of the features that make up the feature spaces, such as {F1, F2, F4, and F5}, {F1, F2, F3, F4, F5, and F6}, etc. Therefore, to efficiently apply a classification algorithm in a real environment, it is necessary to respond to the variable feature space during a classifier learning process.

Several learning algorithms that may be used in variable feature spaces, such as a Generative Learning With Streaming Capricious data (GLSC) and a Prediction With Unpredictable Feature Evolution (PUFE), which may be considered conventional art related to the present disclosure, are proposed, but most of them only deal with cumulative performance from an online learning perspective and do not consider performance from a forgetting or aggregation perspective of knowledge, making it difficult to have robustness in various environments. In addition, as a technology related to the continual learning, attempts are made to improve the average performance of various tasks through rehearsal and normalization techniques, but since the variable feature space is not considered, it is difficult to apply to situations covered in the present disclosure.

### SUMMARY

Embodiments of the present disclosure provide a learning technique that may be applied to progressive classifier learning with respect to a variable feature space, which is very important in machine learning applications in medicine, industry, and finance, so as to solve the problems of the conventional art described above. Unlike existing related technologies, embodiments of the present disclosure provide robust progressive learning algorithm for variable feature spaces that may demonstrate decent performance not only for recently learned feature spaces but also for new feature spaces derived from combinations of previously learned feature spaces and configuration features.

According to an embodiment of the present disclosure, a classifier learning system includes a classifier that trains training data having a feature space including a plurality of features based on a classification algorithm, a feature weight generation module that generates a feature weight based on an artificial neural network and an amount of mutual information between the plurality of features of the training data, and a data sampling module that generates sampling data by performing a feature space restoration operation based on the training data and a previous feature space of previous data on which the training is completed in the classifier, and the classifier trains the sampling data, and the classifier includes a plurality of feature-specific classifiers to which the feature weights corresponding to each of the plurality of features are assigned.

According to an embodiment of the present disclosure, a classifier generation system includes a data collector that collects training data having a feature space including a plurality of features from each of a plurality of environments, and a classifier learning system that trains a classifier based on the training data, and the classifier learning system includes a classifier that trains the training data based on a classification algorithm, a feature weight generation module that generates a feature weight based on an artificial neural network and an amount of mutual information between the plurality of features of the training data, and a data sampling module that generates sampling data by performing a feature space restoration operation based on the training data and a previous feature space of previous data on which the training is completed in the classifier, and the classifier trains the sampling data, and the classifier includes a plurality of feature-specific classifiers to which the feature weights corresponding to each of the plurality of features are assigned.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a classifier generation system according to an embodiment of the present disclosure.

FIG. 2 is a diagram illustrating an example of training data having different feature spaces.

FIG. 3 is a diagram illustrating a feature space restoration operation performed by a data sampling module of FIG. 1.

FIG. 4 is a diagram illustrating an example of a feature weight generation module of FIG. 1.

FIG. 5 is a diagram illustrating an example of an artificial neural network module 233 of FIG. 4.

FIGS. 6 and 7 are diagrams describing generation of second weight for each feature based on second training data in an artificial neural network module of FIGS. 4 and 5.

FIGS. 8 and 9 are diagrams describing generation of second weight for each feature based on third training data in an artificial neural network module of FIGS. 4 and 5.

FIG. 10 is a diagram visualizing parameters of an artificial neural network in the case of simultaneous learning or separate learning.

### DETAILED DESCRIPTION

Specific structural or functional descriptions of embodiments according to the present disclosure disclosed in this specification are exemplified only for the purpose of describing embodiments according to the present disclosure, and the embodiments may be implemented in various forms, not limiting the embodiments described in this specification.

Accordingly, while embodiments according to the present disclosure are susceptible to various modifications and alternative forms, specific embodiments thereof are illustrated by way of example in the drawings and will herein be described in detail. However, this is not intended to limit the embodiments according to the present disclosure to specific disclosed forms, and includes modifications, equivalents, or substitutes included in the spirit and scope of the present disclosure.

Terms used in this specification are only used to describe specific embodiments, and are not intended to limit the present disclosure. Singular expressions may include plural expressions unless the context clearly dictates otherwise. It should be understood that the terms “comprises”, “comprising”, “have”, and/or “having” when used herein, specify the presence of stated features, numbers, steps, operations, elements, and/or components, but do not preclude the presence or addition of one or more other features, numbers, steps, operations, elements, components, and/or groups thereof.

As used herein, the terms “unit” or “module” refer to any combination of software, firmware, and/or hardware configured to provide the functionality described herein. For example, software may be implemented as a software package, code and/or set of instructions or instructions, and hardware, for example, may include hardwired circuitry, programmable circuitry, state machine circuitry, and/or a single or any combination, or assembly of firmware that stores instructions executed by programmable circuitry.

The present disclosure relates to a supervised learning algorithm that facilitates progressive learning, which is not efficiently implemented in conventional machine learning. The present disclosure provides a classifier with improved performance in an environment where the feature space is variable in a supervised learning method that predicts a label of a target feature with respect to data consisting of a number of features (or variables) and a target feature (or a target variable).

In the present disclosure, when an existing model is additionally trained using a new data set, progressive learning is very easy since a new model that encompasses the new data set may be built by adding gradual changes to the existing model.

Hereinafter, with reference to the drawings, a machine learning method for progressive learning according to an embodiment of the present disclosure will be described in detail. In addition, the following embodiments relate to supervised learning for the purpose of classification. However, it is not limited to this, and those skilled in the art will be able to fully understand from the following description that the present disclosure may also be applied to supervised learning for the purpose of regression.

Hereinafter, embodiments of the present disclosure will be described clearly and in detail such that those skilled in the art may easily carry out the present disclosure.

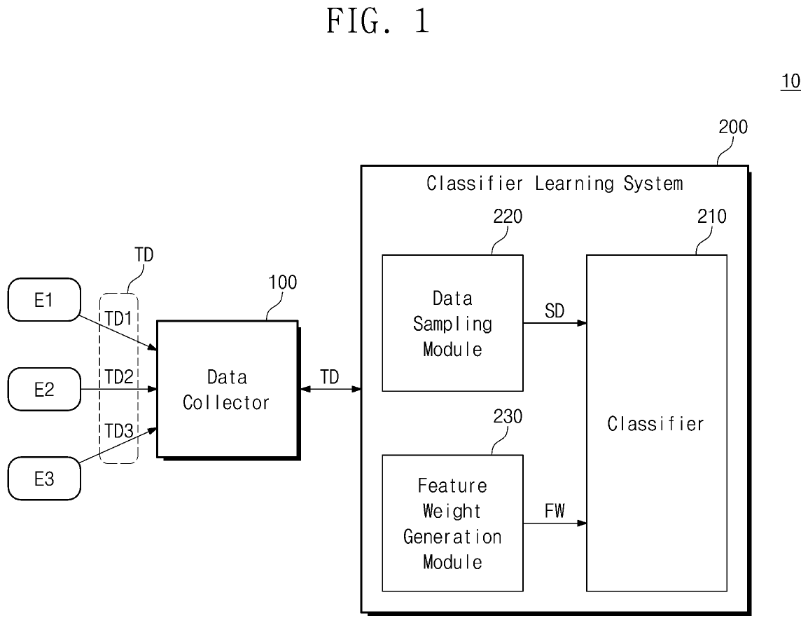

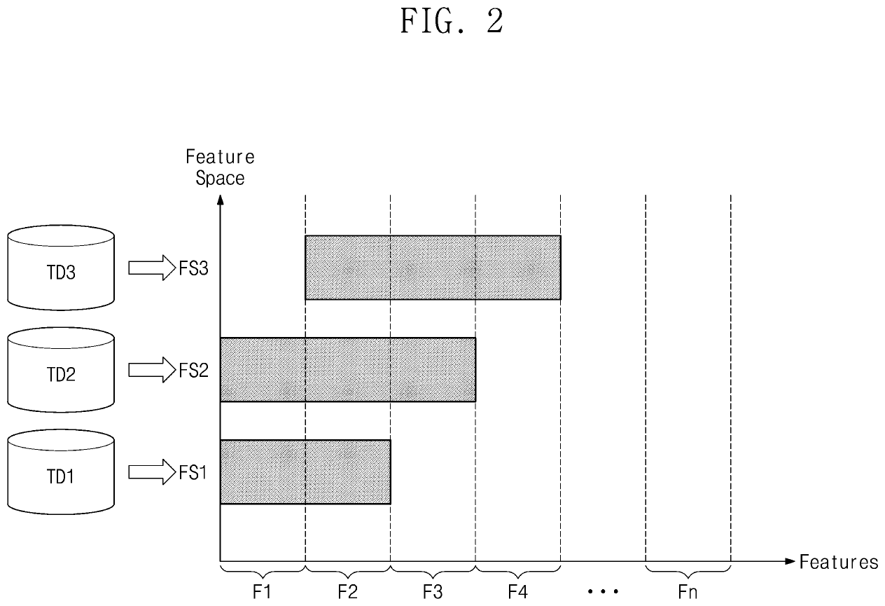

FIG. 1 is a diagram illustrating a classifier generation system according to an embodiment of the present disclosure. FIG. 2 is a diagram illustrating an example of training data having different feature spaces.

Referring to FIG. 1, a classifier generation system 10 may include a data collector 100 and a classifier learning system 200.

The data collector 100 may be configured to collect training data TD from various environments. For example, the various environments may include first to third environments E1, E2, and E3, and the training data TD may include first to third training data TD1, TD2, and TD3.

The data collector 100 may be configured to collect the first training data TD1 from the first environment E1, the second training data TD2 from the second environment E2, and the third training data TD3 from the third environment E3.

For example, the first environment E1 may be a first hospital, the second environment E2 may be a second hospital located in a different place from the first hospital, and the third environment E3 may be a wearable device attached to a user's body. However, the present disclosure is not limited thereto, and the data collector 100 may be configured to collect additional training data TD from other environments.

Each of the training data TD may have a feature space FS including multi-dimensional features. Each of the training data TD may include a target feature (or target variable) corresponding to a class label. Each feature (or variable) may composed of continuous or discrete numeric or character values.

In an embodiment, the training data TD collected in different environments may have different feature spaces. However, for clarity of description, the present disclosure describes collecting training data from different environments, but it will be understood that the content of this disclosure may be equally applied even when the feature space of training data collected in the same environment is variable.

Referring to FIG. 2 together, for example, the first training data TD1 collected from the first environment E1 may include a first feature space FS1 including a first feature F1 and a second feature F2, the second training data TD2 collected from the second environment E2 may include a second feature space FS2 including the first feature F1, the second feature F2, and a third feature F3, and the third training data TD3 collected from the third environment E3 may include a third feature space FS3 including the second feature F2, the third feature F3, and a fourth feature F4.

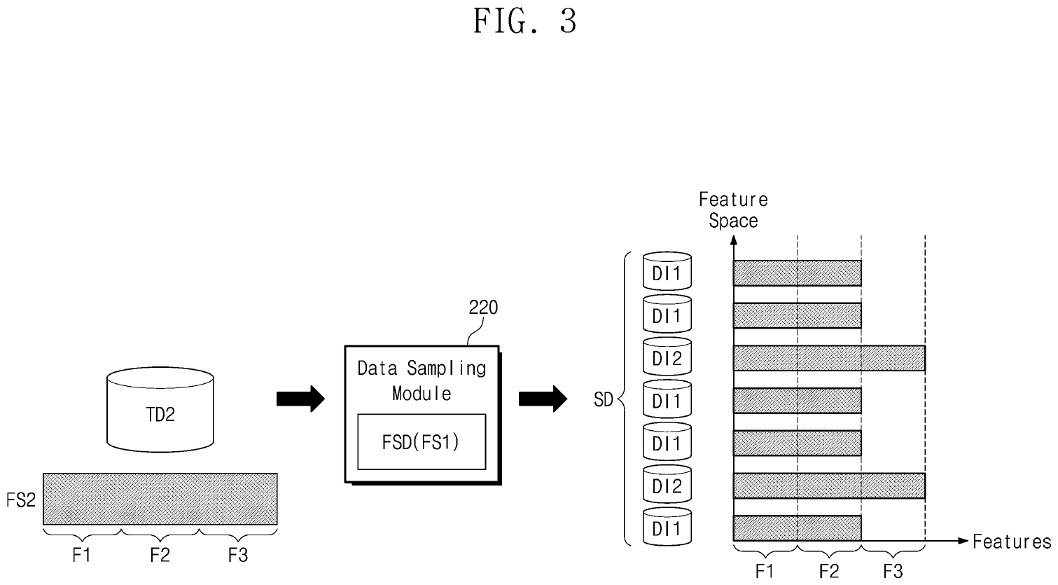

In an embodiment, the second feature space FS2 of the training data TD may include all features of the first feature space FS1 of the first training data TD1. In an embodiment, after training is performed on the first training data TD1 in a classifier 210, performing training on the training data TD2 having the second feature space FS2 including all features of the first feature space FS1 will be described later with reference to FIG. 3.

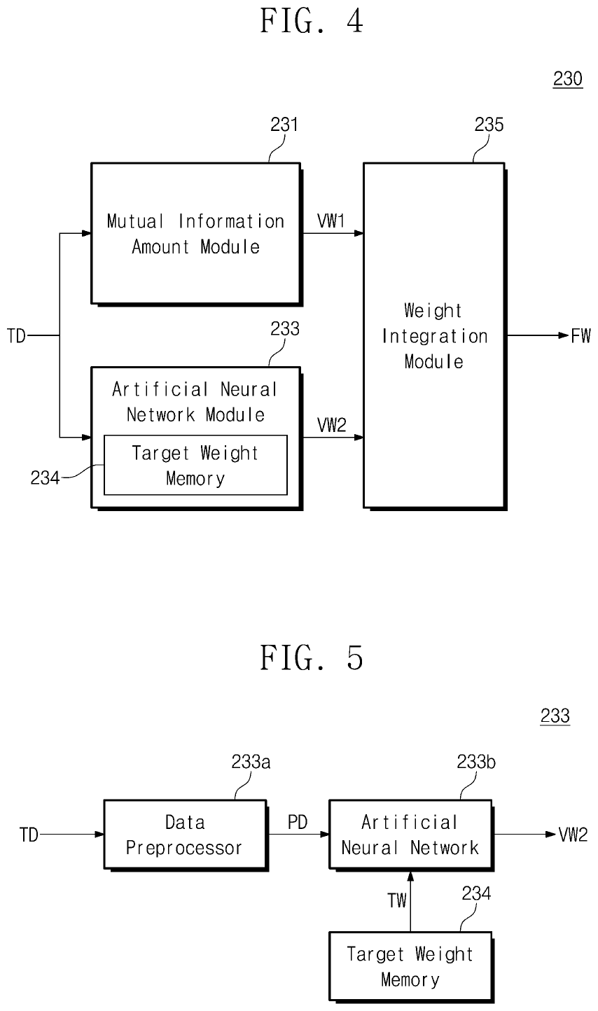

The third feature space FS3 may include some of the features of the second feature space FS2 and may not include the remaining features. In an embodiment, after training is performed on the second training data TD2 in the classifier 210, performing training on the third training data TD3 having the third feature space FS3 including some of the features of the second feature space FS2 will be described later with reference to FIGS. 4 to 9.

In an embodiment, the data collector 100 may be configured to sequentially collect data from the first to third environments E1, E2, and E3. For example, after training on the first training data TD1 collected from the first environment E1 is completed, training on the second training data TD2 collected from the second environment E2 may be performed. For example, after training on the second training data TD2 collected from the second environment E2 is completed, training on the third training data TD3 collected from the third environment E3 may be performed. However, the present disclosure is not limited thereto, and the data collector 100 may sequentially collect data in different orders for different environments.

Referring again to FIG. 1, the classifier learning system 200 may be configured to receive the training data TD from the data collector 100. The classifier learning system 200 may be configured to train the classifier 210 based on the training data TD.

The classifier learning system 200 may include the classifier 210, a data sampling module 220, and a feature weight generation module 230.

The classifier 210 may be configured to train the training data TD (hereinafter, the training data TD includes sampling data SD, which will be described later). In an embodiment, the classifier 210 may be an ensemble of a plurality of feature-specific classifiers corresponding to each of a plurality of features. In detail, the classifier 210 may include the plurality of feature-specific classifiers in which feature weights corresponding to each of the plurality of features are assigned.

The classifier 210 may be configured to train the training data TD based on a classification algorithm. For example, the classification algorithm may be a Naive Bayes algorithm.

The Naive Bayes algorithm finds a value ‘y’ of a target feature ‘Y’ that satisfies an MLE (Maximum likelihood estimation) with respect to data x̅=̅(̅x̅₁̅,̅ .̅ .̅ .̅ ,̅ x̅ₙ̅)̅ existing in a feature space composed of ‘n’ features (̅X̅₁̅,̅ .̅ .̅ .̅ ,̅ X̅ₙ̅). In detail, the Naive Bayes algorithm finds the value ‘y’ of the target feature ‘Y’ that satisfies Equation 1 below.

$${argmax}_{y ∈ Val ( Y )} ( P ( y \vert {x}_{1} , … {x}_{n} ) ) = {argmax}_{y ∈ Val ( Y )} ( \frac{P ( y ) P ( {x}_{1} , … {x}_{n} \vert y )}{P ( {x}_{1} , … {x}_{n} )} ) \qquad [ Equation 1 ]$$

In Equation 1, V̅a̅l̅(̅Y̅)̅ means a set of all values that the feature ‘Y’ may take, and the argmax means an argmax function. In this case, assuming probabilistic independence according to the joint probability distribution between ‘n’ features, Equation 1 may be expressed as Equation 2 below by applying a logarithmic function for computational convenience.

$${argmax}_{y ∈ Val ( Y )} ( P ( y \vert {x}_{1} , … {x}_{n} ) ) = {argmax}_{y ∈ Val ( Y )} ( log P ( y ) + {\sum }_{i = 1}^{n} log P ( {x}_{i} \vert y ) ) \qquad [ Equation 2 ]$$

To implement the classifier 210 optimized for each feature in Equation 2, Equation 3 below may be expressed by applying a feature weight (w̅ᵢ̅) to each feature.

$${argmax}_{y ∈ Val ( Y )} ( P ( y \vert {x}_{1} , … {x}_{n} ) ) = {argmax}_{y ∈ Val ( Y )} ( log P ( y ) + {\sum }_{i = 1}^{n} {w}_{i} log P ( {x}_{i} \vert y ) ) \qquad [ Equation 3 ]$$

In this case, each term (l̅o̅g̅ P̅(̅x̅ᵢ̅|̅y̅)̅) may be viewed as a simple classifier for each feature assigned to each feature, and the classifier 210 may be generated by applying the feature weight (w̅ᵢ̅) to the classifier for each feature and forming an ensemble. In an embodiment, the classifier 210 may be an ensemble of a plurality of feature-specific classifiers corresponding to each of a plurality of features.

However, the classification algorithm used in the classifier 210 according to the present disclosure is not limited to the Naive Bayes, algorithms such as a KNN (K-nearest neighbor), a Decision Tree, and a Random Forest may be used, and the classifier 210 may be generated by applying a classification algorithm by assigning feature weights to each feature.

The feature weight generation module 230 may be configured to generate a feature weight FW based on the amount of mutual information between features of the training data TD and an artificial neural network. The operation of calculating the feature weight FW in the feature weight generation module 230 will be described later with reference to FIGS. 4 to 8.

The data sampling module 220 may be configured to store previous feature space information FSD of training data (hereinafter referred to as previous data) that has been trained in the classifier 210. For example, when training is completed on the first training data TD1 in the classifier 210, the previous feature space information FSD may include information associated with the first feature space FS1 of the first training data TD1. As in the above description, when the classifier 210 has completed training on the first training data TD1 and the second training data TD2, the data sampling module 220 may store information associated with the first and second feature spaces FS2 with respect to the first and second training data TD1 and TD2 as the previous feature space information FSD.

The data sampling module 220 may be configured to receive the training data TD (hereinafter referred to as a current data) from the data collector 100. For example, when the classifier 210 receives the second training data TD2 after completing training on the first training data TD1, the previous data may be the first training data TD1 and the current data may be the second training data TD2.

The data sampling module 220 may be configured to generate the sampling data SD by performing the feature space restoration operation based on the current data and the previous feature space information FSD of the previous data. In an embodiment, when the feature space of the current data includes the feature space of the previous data, the data sampling module 220 may be configured to perform the feature space restoration operation. When the feature space restoration operation is performed, the data sampling module 220 may be configured to sample the current data to generate a plurality of sampling data SD having the same feature space as the feature space of previous data. In another embodiment, when the feature space of the current data does not include at least some of the feature space of the previous data, the data sampling module 220 may not perform the feature space restoration operation and may not generate the sampling data SD.

The sampling data SD generated by the data sampling module 220 may be provided to the classifier 210, and the classifier 210 may be configured to train the sampling data SD. Hereinafter, a detail operation method of the data sampling module 220 will be described with reference to FIG. 3.

FIG. 3 is a diagram illustrating a feature space restoration operation performed by a data sampling module of FIG. 1.

Referring to FIGS. 1 and 3, in an embodiment, it is assumed that the classifier 210 has completed training on the first training data TD1 (i.e., the first training data TD1 is previous data), and then the second training data TD2 is received from the data collector 100 (i.e., the second training data TD2 is current data). In detail, the previous feature space information FSD stored in the data sampling module 220 may include information (information associated with the first feature F1 and the second feature F2) associated with the first feature space FS1.

The data sampling module 220 may be configured to determine whether to perform the feature space restoration operation based on the feature space of the current data and the previous feature space information FSD. When the feature space of the current data includes all features of the feature space of the previous data, the data sampling module 220 may be configured to perform the feature space restoration operation.

For example, since the second feature space FS2 (the first to third features F1, F2, and F3) of the second training data TD2, which is the current data includes the first feature space FS1 (the first and second features F1 and F2) of the first training data TD1, which is the previous data, the data sampling module 220 may be configured to generate the sampling data SD by performing the feature space restoration operation on the second training data TD2.

The feature space restoration operation may include data augmentation and random data sampling.

The data augmentation may be an operation to generate a new data instance by transforming, modifying, or combining the training data TD. For example, when the training data TD is image data, the data augmentation may include image rotation, flipping, cropping, zooming in/out, enhancing brightness, and adding noise. For example, when the training data TD is text data, the data augmentation may include thesaurus-based replacement, random masking, random reordering, synonym insertion, etc. For example, when the training data TD is voice data, the data augmentation may include speed adjustment, noise addition, and voice modulation.

Random data sampling may be an operation that generates a new data instance by randomly shuffling the order of current data. For example, when the training data TD is image data, the random data sampling may include changing object placement, changing image order, etc. For example, when the training data TD is text data, the random data sampling may include changing sentence order, changing word order, etc. For example, when the training data TD is voice data, the random data sampling may include changing an utterance order.

The sampling data SD may include a plurality of data instances generated by performing the feature restoration operation on the current data. The sampling data SD may include first data instances DI1 having the same feature space as the feature space of the previous data and second data instances DI2 having the same feature space as the feature space of the current data. For example, each first data instance DI1 may include data for the feature space (the first feature space FS1) of the previous data (the first training data TD1). For example, each second data instance DI2 may include data for the feature space (the second feature space FS2) of the current data (the second training data TD2).

As in the above description, when the previous data is a plurality of training data TD and the previous feature space information FSD stored in the data sampling module 220 includes a plurality of feature spaces, the sampling data SD may include a plurality of data instances having the same feature space as each of the plurality of feature spaces.

In the case of an embodiment according to the present disclosure, even when the feature space of the collected training data is variable, the feature space restoration operation is performed based on the previous feature space information of the previous data, so that robustness of the classifier may be improved even in the environment where the feature space of the training data trained by the classifier is variable. Accordingly, in the case of an embodiment according to the present disclosure, the issue of catastrophic forgetting may be alleviated.

FIG. 4 is a diagram illustrating an example of a feature weight generation module of FIG. 1.

Referring to FIG. 4, the feature weight generation module 230 may include a mutual information amount module 231, an artificial neural network module 233, and a weight integration module 235.

The mutual information amount module 231 may be configured to receive the training data TD. The mutual information amount module 231 may be configured to generate a first weight VW1 for each feature based on the interdependence between a plurality of features of the training data TD. For example, the mutual information amount module 231 may calculate the first weight VW1 for each feature by quantifying the interdependence between features using the mutual information amount, Spearman, and Pearson correlation coefficients. For example, the mutual information amount has the advantage of being able to handle various interdependencies such as non-linearity and non-monotonicity while enabling simple progressive learning. In an embodiment, the mutual information amount module 231 may be configured to calculate the first weight VW1 for each feature based on the mutual information amount using the Minimum Redundancy Maximum Relevance (mRMR) technique.

The mutual information amount (I) between the features (X̅ᵢ̅,̅ X̅_̅{̅y̅}̅) of the training data TD may be defined as Equation 4 below.

$$I ( {X}_{i} ; {X}_{j} ) = {\sum }_{{x}_{i , k} ∈ Val ( {X}_{i} )} {\sum }_{{x}_{j , l} ∈ Val ( {X}_{j} )} p ( {x}_{i , k} , {x}_{j , l} ) log ( \frac{p ( {x}_{i , k} , {x}_{j , l} )}{p ( {x}_{i , k} ) p ( {x}_{j , l} )} ) \qquad [ Equation 4 ]$$

In Equation 4, V̅a̅l̅(̅X̅ᵢ̅)̅ means a set of all values that a feature X̅ᵢ̅ may take, and x̅_̅{̅i̅,̅k̅}̅ may mean a k-th value of V̅a̅l̅(̅X̅ᵢ̅)̅. V̅a̅l̅(̅X̅ⱼ̅)̅ means a set of all values that a feature X̅ᵢ̅ may take, and x̅_̅{̅j̅,̅l̅}̅ means the l-th value of V̅a̅l̅(̅X̅ⱼ̅)̅. p̅(̅x̅_̅{̅i̅,̅k̅}̅)̅ is the probability of observing a x̅_̅{̅i̅,̅k̅}̅ value, and p̅(̅x̅_̅{̅j̅,̅l̅}̅)̅ means the probability of observing a x̅_̅{̅j̅,̅l̅}̅ value. p̅(̅x̅_̅{̅i̅,̅k̅}̅,̅ x̅_̅{̅j̅,̅l̅}̅)̅ means the conditional probability that the x̅_̅{̅i̅,̅k̅}̅ value will be observed when the x̅_̅{̅j̅,̅l̅}̅ value is observed.

Based on the mutual information amount (I̅(̅X̅ᵢ̅;̅X̅ⱼ̅)̅) between the features (X̅ᵢ̅,̅ X̅ⱼ̅) of the training data TD, the redundancy (R̅(̅X̅ᵢ̅)̅) and suitability (D̅(̅X̅ᵢ̅)̅) of the features (X̅ᵢ̅) may be calculated as illustrated in Equation 5 and Equation 6 below.

$$R ( {X}_{i} ) = \frac{1}{n - 1} {\sum }_{{X}_{j} Λ {X}_{j} \neq {X}_{i}} \frac{I ( {X}_{i} ; {X}_{j} )}{\frac{1}{n ( n - 1 )} {\sum }_{{X}_{i}} {\sum }_{{X}_{j} Λ {X}_{j} \neq {X}_{i}} I ( {X}_{i} ; {X}_{j} )} \qquad [ Equation 5 ]$$

$$D ( {X}_{i} ) = \frac{I ( {X}_{i} ; Y )}{\frac{1}{n} {\sum }_{{X}_{i}} I ( {X}_{i} ; Y )} \qquad [ Equation 6 ]$$

The mutual information module 231 may calculate the first weight VW1 for each feature based on the redundancy ‘R’ and suitability ‘D’ between the features of the training data TD. The first weight VW1 for each feature may be calculated as in Equation 7 below.

$$VW 1 = σ ( D ( {X}_{i} ) - R ( {X}_{i} ) ) \qquad [ Equation 7 ]$$

In Equation 7, σ means a sigmoid function.

In an embodiment, the first weight VW1 for each feature generated by the mutual information amount module 231 is a normalized value and may fall within a range [0,1].

The artificial neural network module 233 may be configured to generate a second weight VW2 for each feature based on the training data TD and the artificial neural network. Hereinafter, the specific configuration and operation of the artificial neural network module 233 will be described later with reference to FIGS. 5 to 9.

The weight integration module 235 may be configured to generate the feature weight FW based on the first weight VW1 for each feature and the second weight VW2 for each feature.

For example, the feature weight FW may be calculated according to Equation 8 below.

$$FW = α VW 1 + ( 1 - α ) VW 2 , α ∈ [ 0 , 1 ] \qquad [ Equation 8 ]$$

When the feature weight FW is calculated, an α value may be set according to the proportion of the first weight VW1 for each feature and the second weight VW2 for each feature. For example, when higher weight is given to the first weight VW1 for each feature in the feature weight FW, the α value may be set to a range between 0.5 and 1. As another example, when higher weight is given to the second weight VW2 for each feature in the feature weight FW, the α value may be set to a range between 0 and 0.5. As another example, when equal weight is given to the first weight for each feature VW1 and the second weight for each feature VW2, the α value may be set to 0.5.

FIG. 5 is a diagram illustrating an example of the artificial neural network module 233 of FIG. 4.

Referring to FIG. 5, the artificial neural network module 233 may include a data preprocessor 233a, an artificial neural network 233b, and a target weight memory 234.

The data preprocessor 233a may be configured to receive the training data TD. The data preprocessor 233a may be configured to generate preprocessed data PD based on the feature space of the training data TD. The preprocessed data PD may be expressed in a vector format obtained by binarizing the feature space of the training data TD. In an embodiment, the preprocessed data PD may have a value of ‘1’ for components corresponding to features included in the feature space of the training data TD, and may have a value of ‘0’ for components corresponding to features not included in the feature space of the training data TD.

The artificial neural network 233b may be configured to output the second weight VW2 for each feature by using preprocessed data PD as an input. The artificial neural network 233b may include an input layer IL including a plurality of input nodes, an output layer OL including a plurality of output nodes, and intermediate layers ML including a plurality of intermediate nodes MN.

The number of input nodes may be the same as the total number of features that may be trained by the classifier 210 of FIG. 1. For example, when the classifier 210 of FIG. 1 includes ‘n’ classifiers for each feature corresponding to each of the ‘n’ features, the number of input nodes may be ‘n’. Each of the input nodes may correspond to each feature of the training data TD. For example, a first input node may correspond to the first feature F1, a second input node may correspond to the second feature F2, and an n-th input node may correspond to the n-th feature.

In an embodiment, the number of output nodes of the artificial neural network may be the same as the number of input nodes.

As described above, the second weight VW2 for each feature output from the output layer OL of the artificial neural network 233b may be integrated with the first weight VW1 for each feature in the weight integration module 235 so as to be provided to the classifier 210 as the feature weight FW.

The artificial neural network 233b may update the second weight VW2 for each feature such that an objective function (also referred to as a loss function) is minimized based on the target weight TW for each feature and the classification result of the classifier 210.

The objective function ‘loss’ for optimization of the artificial neural network 233b may be expressed as Equation 9 below.

$$loss = CE ( \overline{y} , f ( {X}_{1} , … , {X}_{n} ) ) + \frac{λ}{len ( spaces )} \sum MSE ( {w}_{target} , h ( PD ) ) \qquad [ Equation 9 ]$$

In a first term (C̅E̅(̅y̅,̅ f̅(̅X̅₁̅,̅ .̅ .̅ .̅ ,̅ X̅ₙ̅)̅)̅) of Equation 9, CE means a Cross Entropy Loss function, f(X1, . . . , Xn) means the classification result of the classifier 210, and y̅ is the target feature labeled in the input training data. In a second term

$$( \overline{\frac{λ}{len ( spaces )} \sum MSE ( {w}_{target} , h ( PD ) )} )$$

of Equation 9, len(spaces) means the number of feature spaces stored in the target weight memory 234, λ̅ means a normalization factor, MSE means a Mean Square Error, w̅_̅{̅t̅a̅r̅g̅e̅t̅}̅ is the target weight TW for each feature stored in the target weight memory 234, and h (PD) means an output of the artificial neural network 233b.

The classifier 210 may perform training on the training data TD while optimizing the artificial neural network 233b to minimize the objective function of Equation 9. For example, the classifier 210 may be configured to update artificial neural network parameters in a way that may increase the performance of the classifier 210 through differentiation. Since this process follows learning process of a general artificial neural network, it is not described in detail in this disclosure.

After training on the training data TD is completed in the classifier 210, the target weight memory 234 may be configured store the second weight VW2 for each feature output from the artificial neural network 233b as the target weight TW for each feature. Thereafter, the artificial neural network 233b may perform optimization of the artificial neural network 233b based on the target weight TW for each feature stored in the target weight memory 234.

The target weight memory 234 may be provided inside the artificial neural network module 233, but, unlike illustrated, may be provided separately outside the artificial neural network module 233.

In the case of an embodiment according to the present disclosure, even when the feature space of the collected training data TD is variable, the artificial neural network 233b is optimized based on the target weight TW for each feature, so that the robustness of the classifier 210 may be improved even in an environment where the feature space is variable.

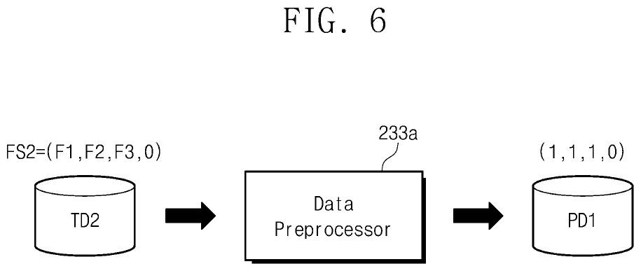

Hereinafter, with reference to FIGS. 6 to 9, a detailed description will be given of how the classifier 210 performs the training on the second training data TD2 by calculating the second weight VW2 for each feature, and then performs the training on the third training data TD3 by calculating the second weight VW2 for each feature.

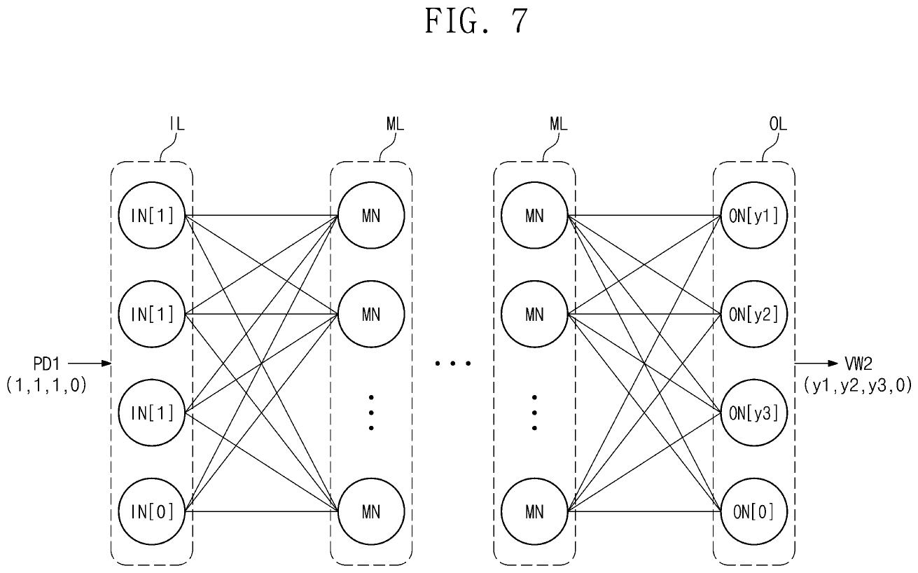

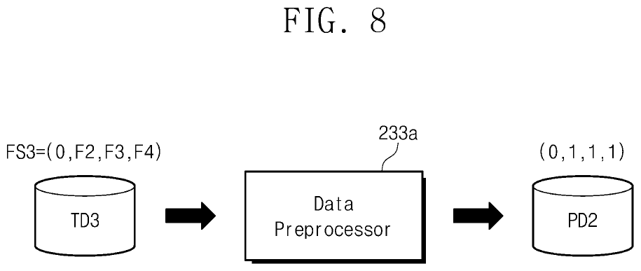

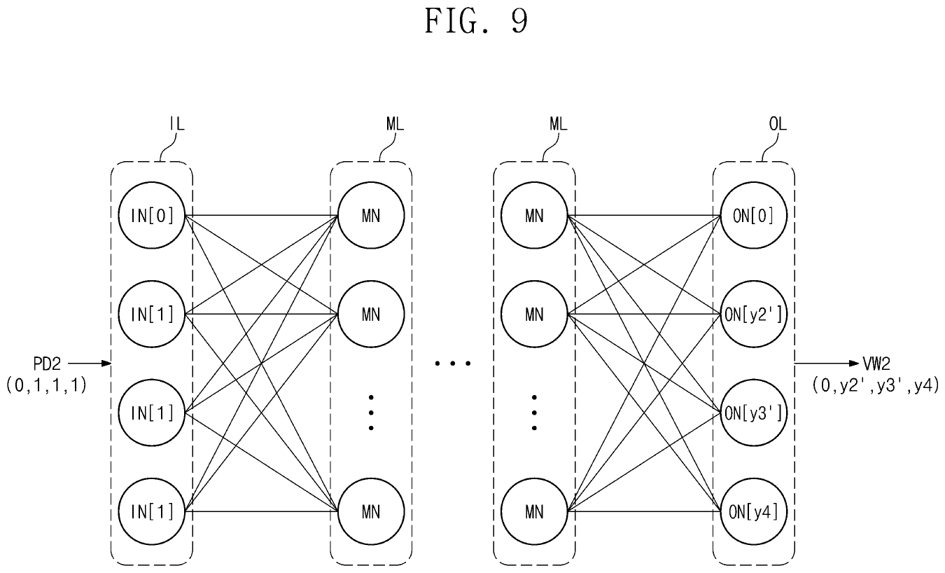

FIGS. 6 and 7 are diagrams describing generation of second weight for each feature based on the second training data TD2 in the artificial neural network module 233 of FIGS. 4 and 5. FIGS. 8 and 9 are diagrams describing generation of second weight for each feature based on the third training data TD3 in the artificial neural network module 233 of FIGS. 4 and 5.

Referring to FIG. 6, the data preprocessor 233a may generate first preprocessed data PD1 based on the second feature space FS2 of the second training data TD2. For example, the second feature space FS2 may include the first feature F1, the second feature F2, and the third feature F3. The total number of components of the first preprocessed data PD1 may be the same as the total number of features that may be trained by the classifier 210. In an example, assuming that the classifier 210 is capable of training four features, the first preprocessed data PD1 may be expressed as 1, 1, 1, and 0.

Referring to FIG. 7, the first preprocessed data PD1 may be input to the input layer IL of the artificial neural network 233b. The number of input nodes IN of the artificial neural network 233b may be the same as the number of components of the first preprocessed data PD1.

Each of the input nodes IN of the input layer IL may correspond to each of the features. For example, the first input node may correspond to the first feature F1, the second input node may correspond to the second feature F2, the third input node may correspond to the third feature F3, and the fourth input node may correspond to the fourth feature F4. In an example, a value of ‘1’ may be input to the first to third input nodes, and a value of ‘0’ may be input to the fourth input node.

Each of the output nodes ON of the output layer OL may correspond to each of the input nodes IN. For example, the first output node may correspond to the first feature F1, the second output node may correspond to the second feature F2, the third output node may correspond to the third feature F3, and the fourth output node may correspond to the fourth feature F4.

When the input value of the input node is ‘1’, the corresponding output node outputs a specific value, but when the input value of the input node is ‘0’, the output node may output ‘0’. In an example, while training the second training data TD2 in the classifier 210, values of y1, y2, and y3 may be output to the first output node, the second output node, and the third output node, respectively, but the value of ‘0’ may be output to the fourth output node. In the process of training the second training data TD2 in the classifier 210, the output values of the first to fourth output nodes may be updated to minimize the objective function based on Equation 9.

When training is completed on the second training data TD2, the final output values of the output layer OL may be stored as target weights TW for each feature in the target weight memory 234.

Referring to FIG. 8, after training on the second training data TD2 is completed, the data preprocessor 233a may generate the second preprocessed data PD2 based on the third feature space FS3 of the third training data TD3. For example, the third feature space FS3 may include the second feature F2, the third feature F3, and the fourth feature F4. In an example, the second preprocessed data PD2 may be expressed as 0, 1, 1, and 1.

Referring to FIG. 9, the second preprocessed data PD2 may be input to the input layer IL of the artificial neural network 233b. Each of the input nodes IN of the input layer IL may correspond to each of the features. In an example, a value of ‘0’ may be input to the first input node, and a value of ‘1’ may be input to the second to fourth input nodes.

Each of the output nodes ON of the output layer OL may correspond to each of the input nodes IN. When the input value of the input node is ‘1’, the corresponding output node may output a specific value. When the input value of the input node is ‘0’, the output node may output the value of ‘0’. In an example, among the output nodes ON whose input value of the corresponding input node is ‘0’, the output nodes ON for which the target weights TW for each feature are stored in the target weight memory 234 may be optimized to output the target weights TW for each feature, and the output nodes ON for which the target weights TW for each feature are not stored in the target weight memory 234 may be optimized to output the value of ‘0’.

While the third training data TD3 is trained in the classifier 210, the value of ‘0’ may be output to the first output node, a value of y2′ may be output to the second output node, a value of y3′ may be output to the third output node, and a value of y4 may be output to the fourth output node. In the process of training the third training data TD3 in the classifier 210, the output values of the first to fourth output nodes may be updated to minimize the objective function based on Equation 9.

As in the above description, when training is completed on the third training data TD3, final output values of the output layer OL may be stored as target weights TW for each feature in the target weight memory 234.

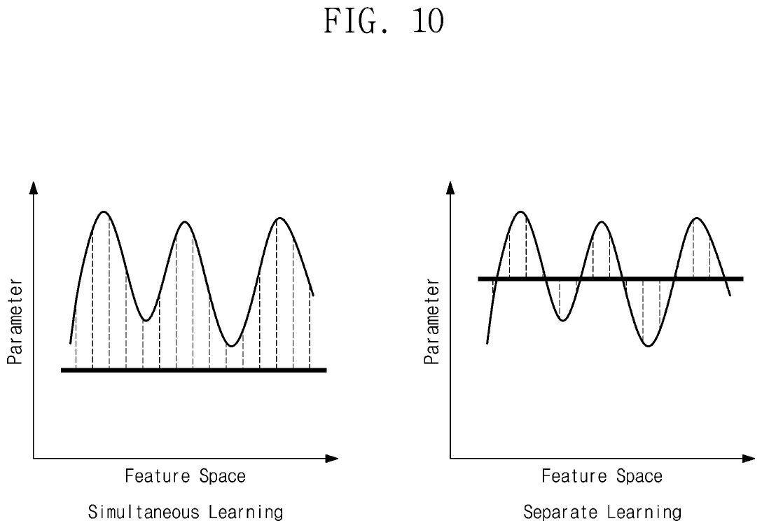

FIG. 10 is a diagram visualizing parameters of an artificial neural network in the case of simultaneous learning or separate learning.

In the process of optimizing an artificial neural network, node-specific parameters assigned to a plurality of nodes of the artificial neural network and edge-specific parameters assigned to edges connecting the plurality of nodes may be updated.

In an embodiment, when optimizing an artificial neural network, parameters for each node and parameters for each edge may be trained separately for the last layer. This is to induce robust characteristics even for unlearned feature spaces.

For example, in the last layer, parameters for each edge receive the output of the previous layer as input, so they may be affected by the feature space, which is the first input. Therefore, it has characteristics that depend on the feature space of the training data TD. In contrast, the parameters for each node are not dependent on the feature space since they are defined as one value regardless of the output of the previous layer. Looking at this from a feature space perspective, the parameters for each node correspond to a type of bias, and the parameters for each edge correspond to variance. Therefore, the case of training together and the case of training separately are visualized for a specific feature as illustrated in FIG. 10. Looking at the left side of FIG. 10, it is necessary to use not only bias but also variance to obtain appropriate weights for each feature space, and looking at the right side of FIG. 10, it is possible to obtain robust weights in most spaces to some extent even by using only bias, so it may be seen that obtained weights may be used in more diverse spaces.

According to an embodiment of the present disclosure, the learning technique improves the robustness of the classifier model in a situation where the feature (or variable) space of the data to be trained by the classifier continuously changes (existing features disappear, new features are added, etc.) without fixing of the feature space. Since the learning technique covered in the present disclosure is designed based on the recently widely used artificial neural network, it may be widely used in various classifiers to which it may be applied.

The present disclosure mainly improves the robustness of the model in two aspects. First, the catastrophic forgetting issue of the model is alleviated through the feature space rehearsal technique, which restores previous feature space information and uses it for learning. Second, a stable model that may provide good performance in a more diverse feature space is generated through the multi-layer weight technique, which obtains the final weight by adding up the weights of several attributes.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims

What is claimed is:

1. A classifier learning system comprising:
a classifier configured to train training data having a feature space including a plurality of features based on a classification algorithm;
a feature weight generation module configured to generate a feature weight based on an artificial neural network and an amount of mutual information between the plurality of features of the training data; and
a data sampling module configured to generate sampling data by performing a feature space restoration operation based on the training data and a previous feature space of previous data on which the training is completed in the classifier, and
wherein the classifier is configured to train the sampling data, and
wherein the classifier includes a plurality of feature-specific classifiers to which the feature weights corresponding to each of the plurality of features are assigned.

2. The classifier learning system of claim 1, wherein the data sampling module is configured to perform the feature space restoration operation when the feature space of the training data includes the feature space of the previous data.

3. The classifier learning system of claim 2, wherein, when the feature space restoration operation is performed, the data sampling module is configured to sample the training data to generate a plurality of data instances having the same feature space as the feature space of the previous data.

4. The classifier learning system of claim 2, wherein the feature space restoration operation includes a data augmentation and a random data sampling.

5. The classifier learning system of claim 1, wherein the classification algorithm includes a Naive Bayes algorithm.

6. The classifier learning system of claim 1, wherein the feature weight generation module includes:
a mutual information amount module configured to generate a first weight for each feature based on interdependence between the plurality of features of the training data;
an artificial neural network module configured to generate a second weight for each feature based on the training data and the artificial neural network; and
a weight integration module configured to generate the feature weight based on the first weight for each feature and the second weight for each feature.

7. The classifier learning system of claim 6, wherein the mutual information amount module is configured to calculate the first weight VW1 for each feature based on the mutual information amount to which an mRMR (Minimum Redundancy Maximum Relevance) technique is applied.

8. The classifier learning system of claim 6, wherein the artificial neural network module includes:
a data preprocessor configured to generate preprocessed data based on the feature space of the training data;
an artificial neural network configured to input the preprocessed data and to output the second weight for each feature; and
a target weight memory configured to store the second weight for each feature output from the artificial neural network as a target weight for each feature, after the training on the training data is completed, and
wherein the artificial neural network is configured to update the second weight for each feature such that an objective function is minimized based on the target weight for each feature and a classification result of the classifier.

9. The classifier learning system of claim 8, wherein, in the preprocessed data, components corresponding to the plurality of features included in the feature space of the training data have a value of ‘1’, and components corresponding to the features not included in the feature space of the training data have a value ‘0’.

10. The classifier learning system of claim 9, wherein the number of input nodes of the artificial neural network is the same as a total number of trainable features in the classifier, and
wherein the number of output nodes of the artificial neural network is the same as the number of the input nodes.

11. The classifier learning system of claim 10, wherein the objective function for optimization of the artificial neural network is represented as Equation 1 below:
$$loss = CE ( \overline{y} , f ( {X}_{1} , … , {X}_{n} ) ) + \frac{λ}{len ( spaces )} \sum MSE ( {w}_{target} , h ( PD ) ) , \qquad [ Equation 1 ]$$
in a first term (CE(y̅, f(X₁, . . . , Xₙ))CE(y̅, f(X₁, . . . , Xₙ))) of Equation 1, CE means a Cross Entropy Loss function, f(X1, . . . , Xn) means the classification result of the classifier, and y̅ is the target feature labeled in the input training data, and in a second term
$$( \frac{λ}{len ( spaces )} \sum MSE ( {w}_{target} , h ( PD ) ) \overline{\frac{λ}{len ( spaces )} \sum MSE ( {w}_{target} , h ( PD ) )} )$$
of Equation 1, len(spaces) means the number of feature spaces stored in the target weight memory, λ̅λ̅ means a normalization factor, MSE means a Mean Square Error, w̅_̅{̅t̅a̅r̅g̅e̅t̅}̅ is the target weight for each feature stored in the target weight memory, and h(PD) means an output of the artificial neural network.

12. A classifier generation system comprising:
a data collector configured to collect training data having a feature space including a plurality of features from each of a plurality of environments; and
a classifier learning system configured to train a classifier based on the training data, and
wherein the classifier learning system includes:
a classifier configured to train the training data based on a classification algorithm;
a feature weight generation module configured to generate a feature weight based on an artificial neural network and an amount of mutual information between the plurality of features of the training data; and
a data sampling module configured to generate sampling data by performing a feature space restoration operation based on the training data and a previous feature space of previous data on which the training is completed in the classifier, and
wherein the classifier is configured to train the sampling data, and
wherein the classifier includes a plurality of feature-specific classifiers to which the feature weights corresponding to each of the plurality of features are assigned.

13. The classifier generation system of claim 12, wherein the plurality of environments include first to third environments,
wherein the training data includes first training data collected from the first environment, second training data collected from the second environment, and third training data collected from the third environment, and
wherein the first training data, the second training data, and the third training data have a different feature space.

14. The classifier generation system of claim 13, wherein a first feature space of the first training data is included in a second feature space of the second training data, and
wherein a third feature space of the third training data includes some of features of the second feature space of the second training data.

15. The classifier generation system of claim 14, wherein, when the classifier completes training on the first training data, the data sampling module is configured to perform a feature space restoration operation on the second training data based on the first feature space of the first training data.

16. The classifier generation system of claim 14, wherein the artificial neural network module includes:
a data preprocessor configured to generate preprocessed data based on the feature space of the training data;
an artificial neural network configured to input the preprocessed data and to output a second weight for each feature; and
a target weight memory configured to store the second weight for each feature output from the artificial neural network as a target weight for each feature, after the training on the training data is completed, and
wherein the artificial neural network is configured to update the second weight for each feature such that an objective function is minimized based on the target weight for each feature and a classification result of the classifier.

17. The classifier generation system of claim 16, wherein the objective function for optimization of the artificial neural network is represented as Equation 2 below:
$$loss = CE ( \overline{y} , f ( {X}_{1} , … , {X}_{n} ) ) + \frac{λ}{len ( spaces )} \sum MSE ( {w}_{target} , h ( PD ) ) , \qquad [ Equation 2 ]$$
in a first term (CE(y̅, f(X₁, . . . , Xₙ))CE(y̅, f(X₁, . . . , Xₙ))) of Equation 2, CE means a Cross Entropy Loss function, f(X1, . . . , Xn) means the classification result of the classifier, and y̅ is the target feature labeled in the input training data, and in a second term
$$( \frac{λ}{len ( spaces )} \sum MSE ( {w}_{target} , h ( PD ) ) \overline{\frac{λ}{len ( spaces )} \sum MSE ( {w}_{target} , h ( PD ) )} )$$
of Equation 2, len(spaces) means the number of feature spaces stored in the target weight memory, λ̅λ̅ means a normalization factor, MSE means a Mean Square Error, w̅_̅{̅t̅a̅r̅g̅e̅t̅}̅ is the target weight for each feature stored in the target weight memory, and h(PD) means an output of the artificial neural network.

18. The classifier generation system of claim 17, wherein, when the classifier completes training on the second training data, the target weight memory is configured to store the second weight for each feature output from the artificial neural network as the target weight for each feature.
